(19) United States
(12) Patent Application Publication
(10) Pub. No.: US 2015/0227493 A1
(43) Pub. Date: Aug. 13, 2015

(54) DISPLAY SYSTEM, DISPLAY APPARATUS, DISPLAY METHOD, AND COMPUTER PROGRAM

(71) Applicant: SEIKO EPSON CORPORATION, Tokyo (JP)

(72) Inventors: Hirokazu ISHIDA, Matsumoto-shi (JP); Takeshi WADA, Shiojiri-shi (JP)

(21) Appl. No.: 14/615,276

(22) Filed: Feb. 5, 2015

(30) Foreign Application Priority Data
Feb. 7, 2014 (JP) 2014-022432

(51) Int. Cl. G06F 17/21; G06F 13/42

(52) U.S. Cl. CPC G06F 17/212; G06F 13/4221

(57) ABSTRACT

Display apparatuses 10A and 10B store at least one document file that is the same. When a keyword search is performed in the display apparatus 10A, a list of search results is displayed in the display apparatus 10A. When one of the search results in the displayed list is selected, the display apparatus 10A transmits information specifying a portion corresponding to the selected search result to the display apparatus 10B. The display apparatus 10B specifies a portion to be displayed on the document, using the information transmitted from the display apparatus 10A, and displays an image of the specified portion.

### BACKGROUND

1. Technical Field

The present invention relates to a display system, a display apparatus, a display method, and a computer program.

2. Related Art

Inventions for displaying information by coordinating a plurality of terminal apparatuses include a coordinated display system disclosed in JP-A-2013-218662, for example. In this coordinated display system, an e-mail message list screen is displayed on a first terminal apparatus, and when an e-mail message is selected from the list, the first terminal apparatus queries a second terminal apparatus as to whether the second terminal apparatus has an application (mailer) for performing coordinated display. In the case where the second terminal apparatus has an application for performing coordinated display, the first terminal apparatus transmits a command including coordination application information indicating the mailer and contents information of the selected e-mail message to the second terminal apparatus. The second terminal apparatus, upon receipt of the command transmitted from the first terminal apparatus, activates the mailer based on the coordination application information that is included in the command. Also, the second terminal apparatus generates image information for displaying the contents information of the e-mail message based on the contents information that is included in the command, and displays an image of the generated image information.

According to the coordinated display system of JP-A-2013-218662, the contents of the selected e-mail message can be read on the second terminal apparatus, while the e-mail message list screen is being displayed on the first terminal apparatus. However, in this system, the contents information of an e-mail message to be displayed on the second terminal apparatus is transmitted from the first terminal apparatus to the second terminal apparatus every time an e-mail message is selected from the e-mail message list, thus requiring time for the apparatuses to communicate.

### SUMMARY

An advantage of some aspects of the invention is to suppress the amount of communication between one display apparatus and another display apparatus when displaying an image in the other display apparatus in response to a selection made from a list displayed on the one display apparatus.

A display system according to an aspect of the invention includes a first display apparatus and a second display apparatus. The first display apparatus includes a first display unit, a first list generation unit that generates, for display on the first display unit, a list of objects that are in a document, and a first transmission unit that transmits first position information showing a position of an object selected from the list displayed on the first display unit to the second display apparatus, and the second display apparatus includes a second display unit, a second reception unit that receives the first position information transmitted from the first display apparatus, and a second display control unit that causes the second display unit to display a position that is specified by the first position information received by the second reception unit. Also, the second display apparatus includes a second list generation unit that generates, for display on the second display unit, a list of objects that are in a document, and a second transmission unit that transmits second position information showing a position of an object selected from the list displayed on the second display unit to the first display apparatus, and the first display apparatus includes a first reception unit that receives the second position information transmitted from the second display apparatus, and a first display control unit that causes the first display unit to display a position that is specified by the second position information received by the first reception unit.

According to the invention, the amount of communication between one display apparatus and another display apparatus can be suppressed when displaying an image in the other display apparatus in response to a selection made from a list displayed on the one display apparatus.

Also, in the invention, a configuration may be adopted in which the first display apparatus and the second display apparatus cancel transmission of the position information, in a case where the other display apparatus is performing communication at a time of starting transmission of the position information.

According to this configuration, it is possible to ensure that display in the display apparatus that is currently performing communication is not changed.

Also, in the invention, a configuration may be adopted in which, in the first display apparatus, in a case where there is not a display apparatus to serve as a transmission destination of the first position information, the first display control unit causes the first display unit to display the position that is specified by the first position information, and in the second display apparatus, in a case where there is not a display apparatus to serve as a transmission destination of the second position information, the second display control unit causes the second display unit to display the position that is specified by the second position information.

According to this configuration, a position that is specified in a document by position information can be displayed, in the case where communication with another display apparatus is not possible.

Also, in the invention, a configuration may be adopted in which the first display apparatus and the second display apparatus transition to a power saving mode, in a case where a user operation is not performed within a predetermined time period.

According to this configuration, the power consumption of a display apparatus can be suppressed.

Also, in the invention, a configuration may be adopted in which the document is a document divided into pages, and the position information includes a page number and document identification information that indicates the document.

According to this configuration, the amount of the information that is transmitted when displaying a document in another display apparatus can be suppressed.

Also, in the invention, a configuration may be adopted in which the list is a list of search results for objects, and the position information includes document identification information, a search keyword, and a page number of a page containing the keyword.

According to this configuration, a list of search results is displayed and a position in a document corresponding to a search result selected from the displayed list can be displayed in another display apparatus.

Also, in the invention, a configuration may be adopted in which the display system includes a third display unit, a third list generation unit that generates, for display on the third display unit, a list of objects that are in a document, a third transmission unit that transmit third position information showing a position of an object selected from the list displayed on the third display unit to another display apparatus, a third reception unit that receives position information transmitted from another display apparatus, and a third display control unit that causes the third display unit to display a position that is specified by the position information received by the third reception unit.

According to this configuration, a list of search results is displayed in one display apparatus, and the position in the document corresponding to a search result selected from the displayed list can be displayed on a plurality of other display apparatuses.

Also, in the invention, a configuration may be adopted in which the display apparatuses, in a case where a predetermined operation is performed, display an image that was displayed immediately before an image being displayed when the operation was performed.

According to this configuration, the document that was displayed immediately before can be easily displayed.

Also, a display apparatus according to an aspect of the invention includes a display unit, a list generation unit that generates, for display on the display unit, a list of objects that are in a document, a transmission unit that transmits position information showing a position of an object selected from the list displayed on the display unit to another display apparatus, a reception unit that receives position information transmitted from another display apparatus, and a display control unit that causes the display unit to display a position that is specified by the position information received by the reception unit.

According to this configuration, the amount of communication between one display apparatus and another display apparatus can be suppressed when displaying an image in the other display apparatus in response to a selection made from a list displayed on the one display apparatus.

Also, a display method according to an aspect of the invention includes a list generation step of generating, for display on a display unit, a list of objects that are in a document, a transmission step of transmitting position information showing a position of an object selected from the list displayed on the display unit to another display apparatus, a reception step of receiving the position information transmitted from another display apparatus, and a display control step of causing the display unit to display a position that is specified by the position information received in the reception step.

According to this configuration, the amount of communication between one display apparatus and another display apparatus can be suppressed when displaying an image in the other display apparatus in response to a selection made from a list displayed on the one display apparatus.

Also, a computer program according to an aspect of the invention is for causing a computer to execute a list generation step of generating, for display on a display unit, a list of objects that are in a document, a transmission step of transmitting position information showing a position of an object selected from the list displayed on the display unit to another display apparatus, a reception step of receiving the position information transmitted from another display apparatus, and a display control step of causing the display unit to display a position that is specified by the position information received in the reception step.

According to this configuration, the amount of communication between one display apparatus and another display apparatus can be suppressed when displaying an image in the other display apparatus in response to a selection made from a list displayed on the one display apparatus.

### BRIEF DESCRIPTION OF THE DRAWINGS

The invention will be described with reference to the accompanying drawings, wherein like numbers reference like elements.

FIG. 1 shows apparatuses constituting a display system 1 according to a first embodiment of the invention.

FIG. 2 shows a hardware configuration of a display apparatus 10.

FIG. 3 shows functions of the display apparatus 10.

FIG. 4 shows an exemplary screen that is displayed in the display apparatus 10.

FIG. 5 shows an exemplary screen that is displayed in the display apparatus 10.

FIG. 6 shows an exemplary screen that is displayed in the display apparatus 10.

FIG. 7 shows an exemplary screen that is displayed in the display apparatus 10.

FIG. 8 is a flowchart showing the flow of processing that is executed by a control unit 100.

FIG. 9 is a flowchart showing the flow of processing that is executed by the control unit 100.

FIG. 10 shows an exemplary screen that is displayed in the display apparatus 10.

FIG. 11 shows an exemplary screen that is displayed in the display apparatus 10.

FIG. 12 is a flowchart showing the flow of processing that is executed by the control unit 100.

FIG. 13 is a flowchart showing the flow of processing that is executed by the control unit 100.

FIG. 14 is a flowchart showing the flow of processing that is executed by the control unit 100.

FIG. 15 shows an exemplary screen that is displayed in the display apparatus 10.

FIG. 16 shows functions of a display apparatus 10 of a second embodiment.

FIG. 17 is a flowchart showing the flow of processing that is executed by the control unit 100 of the second embodiment.

FIG. 18 shows a hardware configuration of a computer apparatus 20 of a third embodiment.

FIG. 19 shows functions of a computer apparatus 20 of the third embodiment.

FIG. 20 shows an exemplary screen that is displayed on a display unit 207.

FIG. 21 is a flowchart showing the flow of processing that is executed by a control unit 200.

FIG. 22 is a flowchart showing the flow of processing that is executed by the control unit 200.

### DESCRIPTION OF EXEMPLARY EMBODIMENTS

### First Embodiment

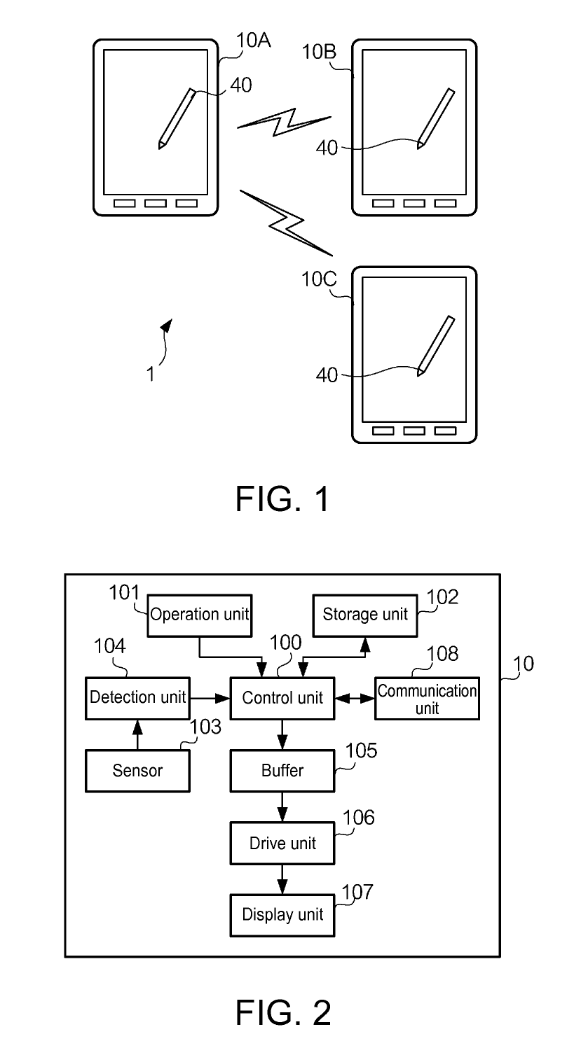

FIG. 1 shows apparatuses constituting a display system 1 according to one embodiment of the invention. Display apparatuses 10A to 10C are apparatuses that have electrophoretic electronic paper as the display device, and display documents corresponding to document files. The display apparatuses 10A to 10C have respectively the same configuration, and, hereinafter, will thus be denoted as “display apparatus 10” in the case where it is not necessary to distinguish between the individual display apparatuses.

The display apparatus 10 has a sensor that detects the position of the tip of a stylus pen 40. When the stylus pen 40 is moved on a display area of the display apparatus 10, the display apparatus 10 detects the position of the tip of the stylus pen 40 that has moved with the sensor. In the case where one of icons for executing various processing are displayed at the position of the detected stylus pen 40, the display apparatus 10 executes processing according to the icon displayed at the detected position.

### Configuration of Display Device 10

FIG. 2 shows a hardware configuration of the display apparatus 10. A display unit 107 is electrophoretic electronic paper in which pixels are arrayed in a plurality of rows and columns. The display unit 107 is an exemplary display device that holds the image displayed even when power is not supplied, that is, an exemplary display device provided with a display area having memory. Note that the display unit 107 may be electronic paper using quick response liquid powder display (QR-LPD) technology. Also, the display unit 107 is not limited to electronic paper, and may be a liquid crystal display or an organic electroluminescence display.

A buffer (frame buffer) 105 is a memory that stores data corresponding to an image to be displayed on the display unit 107. The buffer 105 has a storage area that stores, for each pixel of the display unit 107, a gradation value of the pixel. Data representing the gradation value of each pixel is written to the storage area of the pixel by a control unit 100. A drive unit 106 has a drive circuit that drives the display unit 107. The drive unit 106 reads out the data of the gradation values stored in the buffer 105, and drives the pixels of the display unit 107 based on the read data.

A storage unit 102 has a nonvolatile memory and stores document files. In the present embodiment, the document files are in portable document format (PDF) according to which the document is divided into pages, but the document file format is not limited to PDF and may be another format. An operation unit 101 has a plurality of buttons for operating the display apparatus 10. A communication unit 108 is a communication interface that performs wireless communication. The communication unit 108 performs communication in conformity with Bluetooth® communication standards. Note that the communication standards that the communication unit 108 conforms to are not limited to Bluetooth, and communication may be performed in conformity with IrDA or wireless LAN standards.

A sensor 103 is a planar sensor that detects the position of the tip of the stylus pen 40 with an electromagnetic induction system. In the present embodiment, the area in which the sensor 103 detects the position of the tip of the stylus pen 40 is the same display area as the display area of the display unit 107, but the position of the tip of the stylus pen 40 may be detected in an area larger than the display area of the display unit 107. Note that the display apparatus 10 may be configured to detect the position of the tip of the stylus pen 40 with another system other than the electromagnetic induction system, such as an electrostatic capacitance system.

A detection unit 104 drives the sensor 103 at a predetermined period, and analyzes the signal that is output from the sensor 103. The detection unit 104 specifies the position of the tip of the stylus pen 40 on the display unit 107 through analyzing the signal that is output from the sensor 103, and outputs data showing the specified position to the control unit 100.

The control unit 100 is a microcomputer provided with a central processing unit (CPU), a read only memory (ROM), and a random access memory (RAM). Various functions are realized in the display apparatus 10, when the CPU reads out a computer program stored in the ROM and executes the read program with the RAM as a work area. Functions that are realized in the display apparatus 10 include, for example, a function of displaying documents corresponding to document files stored in the storage unit 102, a function of adding handwritten lines to a displayed document, a function of applying character formatting to the characters of a displayed document, a function of searching for character strings, character formatting, handwritten lines and the like in a document, and a function of coordinating with another display apparatus 10. Since the same programs are in the control units 100 of the display apparatuses 10A to 10C, the same functions are realized in the display apparatuses 10A to 10C.

Note that although the display apparatuses 10A to 10C have the same configuration, hereinafter, in the case where the individual elements of the display apparatuses 10A to 10C need to be distinguished from each other, description will be given with “A” appended to the end of the reference sign of each element of the display apparatus 10A, “B” appended to the end of the reference sign of each element of the display apparatus 10B, and “C” appended to the end of the reference sign of each element of the display apparatus 10C for convenience of description.

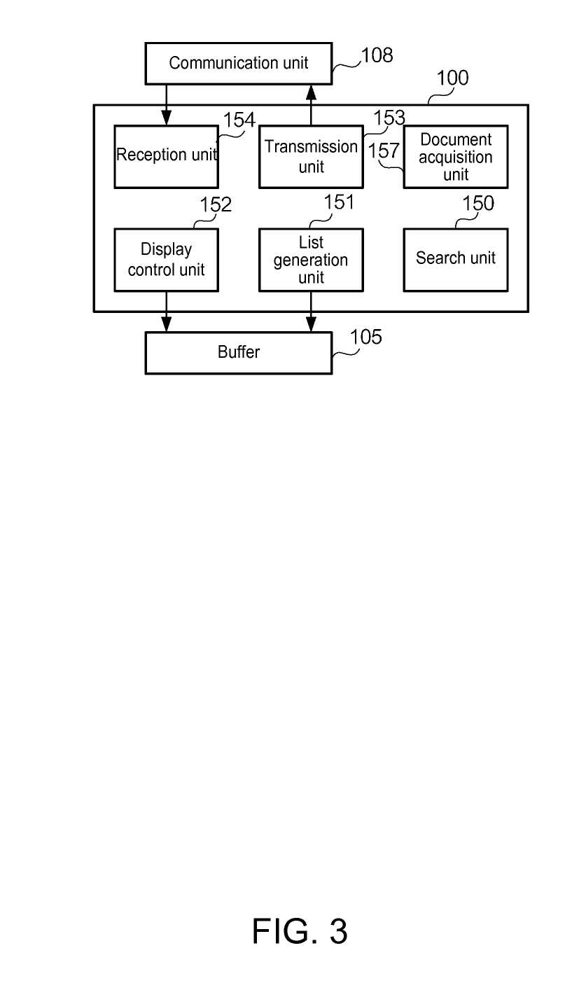

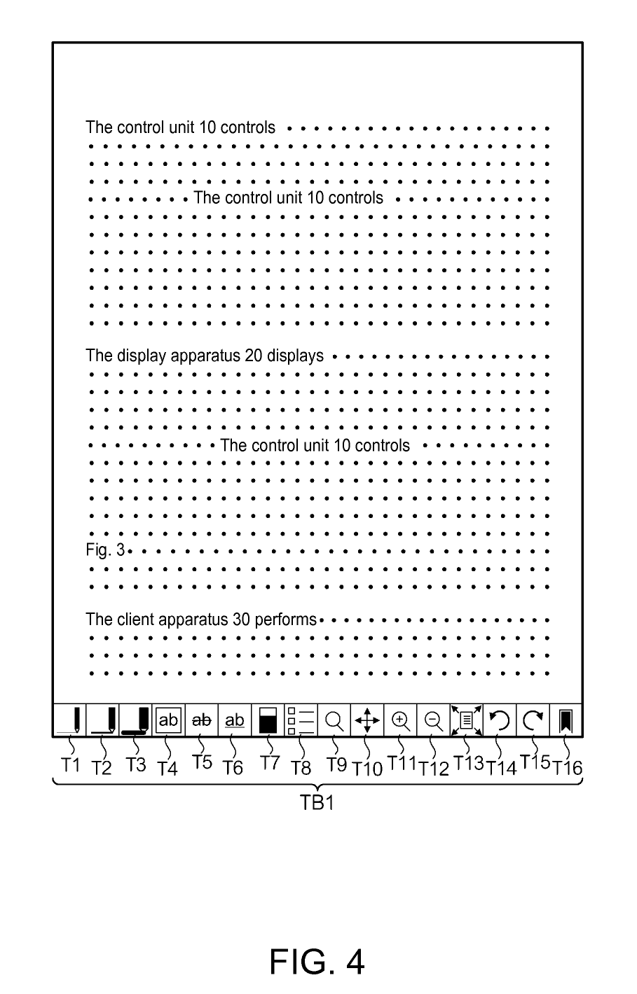

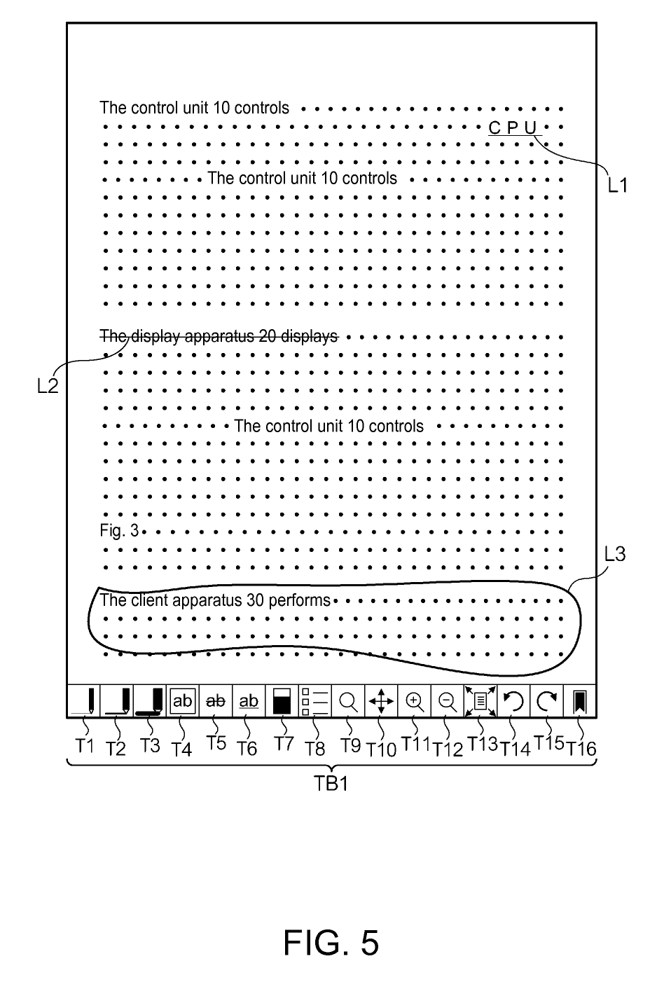

FIG. 3 is a functional block diagram showing functions of the display apparatus 10. A search unit 150 searches a document in a specified document file with a search key designated by the user. A list generation unit 151 generates a list of objects in a document, generates an image of the list, and writes the generated image data to the buffer 105. Since images are displayed on the display unit 107 based on data written to the buffer 105, the list generation unit 151 is a functional block that displays a list on the display unit 107. A transmission unit 153 controls the communication unit 108 to transmit position information associated with an object selected from the list of objects to another display apparatus 10. A reception unit 154 controls the communication unit 108 and receives position information transmitted from another display apparatus 10. A display control unit 152 specifies a position in a document, based on the position information received by the reception unit 154, and writes the data of an image of the portion at the position specified in the document to the buffer 105. Since an image is displayed on the display unit 107 based on the data written to the buffer 105, the display control unit 152 is a functional block that controls the display unit 107 to display a document. A document acquisition unit 157 controls the communication unit 108, and acquires a document that is specified by position information received by the reception unit 154 from another display apparatus 10 that transmitted the position information.

### Exemplary Operations of First Embodiment

Hereinafter, exemplary operations of the first embodiment that are performed when displaying a document, when adding supplementary postscripts to a document, when searching a document, and when displaying search results will be described with reference to the drawings.

Exemplary Operations when Displaying a Document

When the user of the display apparatus 10A performs an operation for opening a document file stored in the storage unit 102A, the control unit 100A acquires the document file from the storage unit 102A, and writes the data of an image showing a document to the buffer 105A in accordance with the acquired document file. When the drive unit 106A drives the display unit 107A based on the data written to the buffer 105A, a document corresponding to the document file is displayed, as illustrated in FIG. 4. Note that a tool bar TB1 for performing various processing on the displayed document is also displayed on the display unit 107A. The tool bar TB1 includes icons T1 to T16 for executing various processing.

Exemplary Operations when Adding Supplementary Postscripts to a Document

When the user taps the icon T6 with the stylus pen 40, it becomes possible to underline a character string displayed on the display unit 107. When the user moves the stylus pen 40 over a character string displayed on the display unit 107 after tapping the icon T6 with the stylus pen 40, the control unit 100A writes the data of an image in which an underline is added to the character string in the portion over which the stylus pen 40 was moved to the buffer 105A. Also, the control unit 100A appends data indicating the underline added to the character string, such as the length and position of the underline, to the document file. When the drive unit 106A drives the display unit 107A based on the data written to the buffer 105A, an image in which the character string is underlined is displayed on the display unit 107A.

When the user taps the icon T5 with the stylus pen 40, it becomes possible to add a strikethrough to a character string displayed on the display unit 107. When the user moves the stylus pen 40 over a character string displayed on the display unit 107 after tapping the icon T5 with the stylus pen 40, the control unit 100A writes the data of an image in which a strikethrough is added to the character string in the portion over which the stylus pen 40 was moved to the buffer 105A. Also, the control unit 100A appends data indicating the strikethrough added to the character string, such as the length and position of the strikethrough, to the document file. When the drive unit 106A drives the display unit 107A based on the data written to the buffer 105A, an image in which the character string is struck through is displayed on the display unit 107A.

When the user taps one of the icons T1 to T3 with the stylus pen 40, it becomes possible to add a handwritten line to the document. When the user moves the stylus pen over a display area of the display unit 107A after tapping one of the icons T1 to T3 with the stylus pen 40, the control unit 100A writes the data of an image in which a line indicating the movement locus of the stylus pen 40 has been added to the buffer 105A. Also, the control unit 100A appends data indicating the added line to the document file. When the drive unit 106A drives the display unit 107A based on the data written to the buffer 105A, an image in which a line indicating the movement locus of the stylus pen 40 has been added is displayed on the display unit 107A.

FIG. 5 shows an exemplary state in which supplementary postscripts have been added to a displayed document. As described above, an underline L1 is displayed when processing for adding an underline is performed, a strikethrough L2 is displayed when processing for adding a strikethrough is performed, and a handwritten line L3 is displayed when processing for adding a handwritten line is performed. Underlines, strikethroughs, and handwritten lines are examples of objects in a document.

Exemplary Operations when Searching for a Character String in a Document

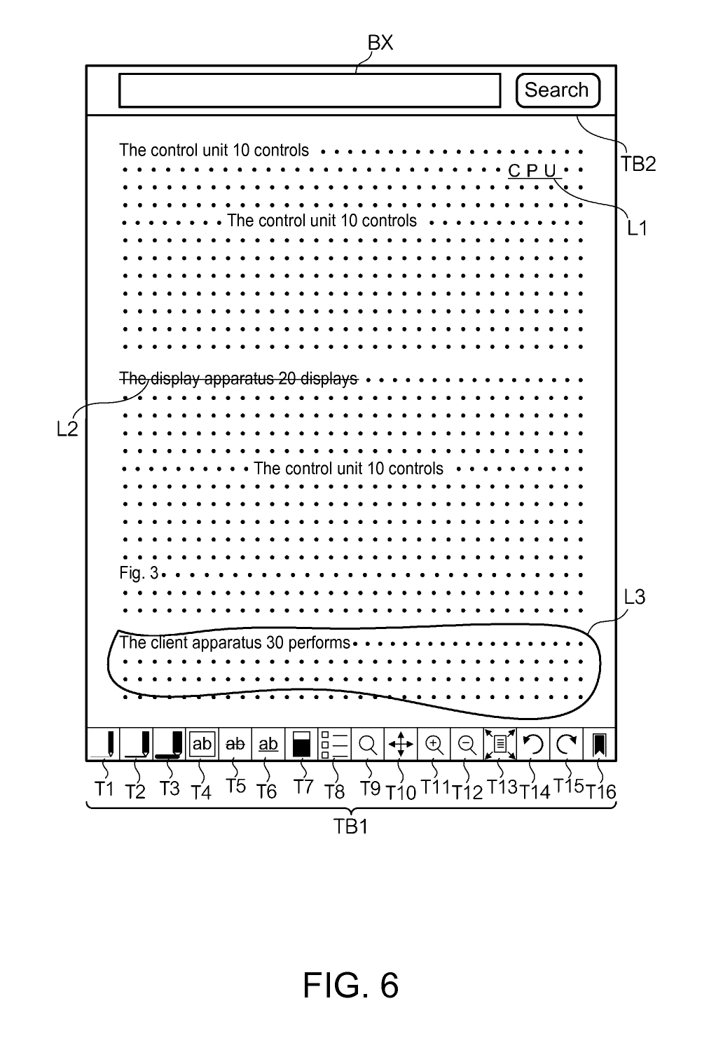

Next, exemplary operations when searching for a character string in a document will be described. When the user taps the icon T9 with the stylus pen 40, the control unit 100A writes the data of an image of a tool bar TB2 having a text box BX to the buffer 105A. When the drive unit 106A drives the display unit 107A based on the data written to the buffer 105A, an image of the tool bar TB2 is displayed on the display unit 107A, as illustrated in FIG. 6.

When the user taps the area in the text box BX with the stylus pen 40, the control unit 100A writes the data of an image of a software keyboard to the buffer 105A. When the drive unit 106A drives the display unit 107A based on the data written to the buffer 105A, a software keyboard is displayed. When the user taps characters on the software keyboard with the stylus pen 40, the control unit 100A writes data to the buffer 105A, based on the characters at the positions tapped with the stylus pen 40. The characters that are at the positions tapped with the stylus pen 40 are thereby displayed in the text box BX.

When the user taps a “search” button that is on the tool bar TB2 with the stylus pen 40, the control unit 100A searches the document file of the displayed document with the character string in the text box BX as a keyword (search key). The character string of this keyword is an example of an object in the document. The control unit 100A, in the keyword search, specifies pages on which the keyword appears, and gives a number (hereinafter referred to as a “hit number”) to each “hit” of the keyword on the specified pages. The hit number is a number that is given sequentially to each hit of the keyword on each page. For example, in the case where the keyword appears three times on the first page of the document, 1 is given as the hit number to the first hit for the keyword from the head of the first page, 2 is given as the hit number to the second hit for the keyword, and 3 is given as the hit number to the third hit for the keyword. Similarly, with regard to the nth page of the document, 1 is given as the hit number to the first hit of the keyword from the head of the nth page, and 2 is given as the hit number to the second hit of the keyword.

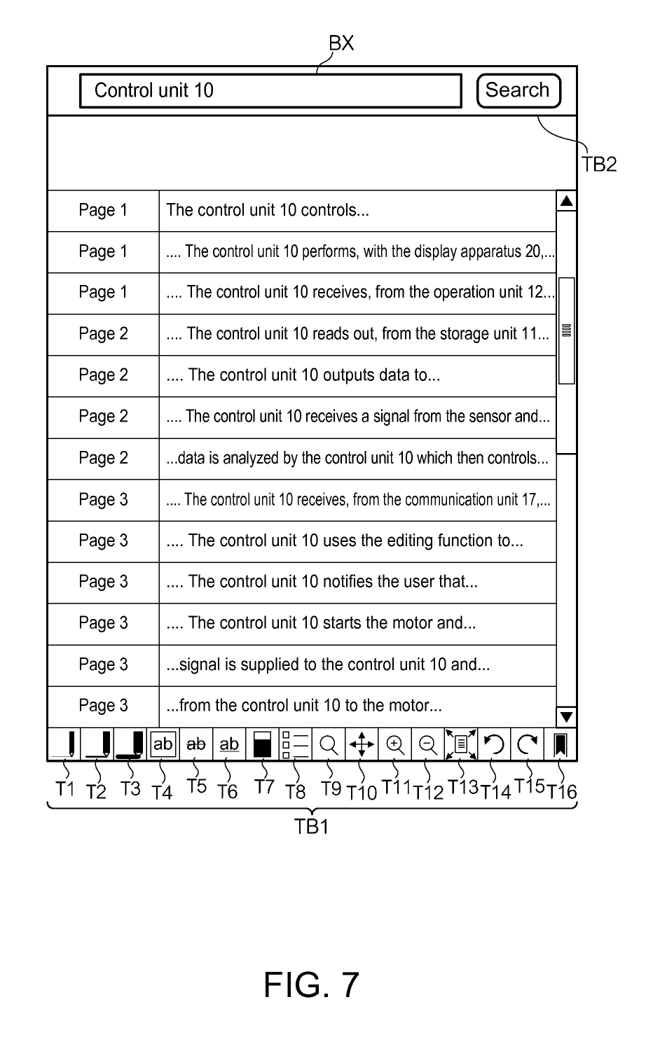

When the keyword search has ended, the control unit 100A (list generation unit 151) generates a list of search results, generates image data based on the list, and writes the generated image data to the buffer 105A. When the drive unit 106A drives the display unit 107A based on the data written to the buffer 105, the list of search results is displayed on the display unit 107A. Since the character string of the keyword is an example of an object in a document, the list of search results can be taken as an exemplary list of the search results of an object. As illustrated in FIG. 7, the page numbers of pages containing the keyword and sections containing the keyword are displayed in the list that is displayed. FIG. 7 illustrates the case where the keyword is “control unit 10”, and in the case where, for example, the keyword “control unit 10” appears three times on the first page of the document, “control unit 10” is displayed three times on the first page of the document, as illustrated.

Note that the control unit 100A associates position information showing a position of the keyword in the document with the display area of each line of the displayed list. The position information includes, for example, the filename (document identification information) of the document file that was searched, the page number included in the line, the hit number of the keyword included in the line, and the keyword. For example, 1 is included as the page number in the position information associated with the first line of the list illustrated in FIG. 7, 1 is included as the hit number, and “control unit 10” is included as the keyword.

Exemplary Operations when a Search Result is Selected

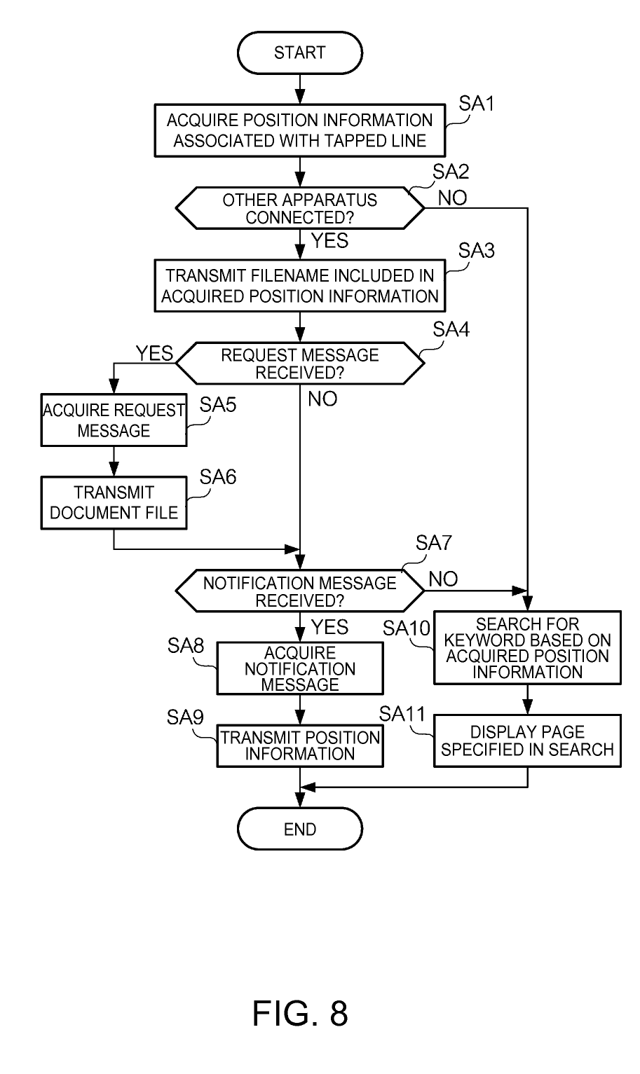

FIG. 8 is a flowchart showing the flow of processing that is performed by the control unit 100 when one of the lines of a list of search results for a keyword is selected. When, in a state where a list of search results is displayed on the display unit 107A, the user taps one of the lines of the list with the stylus pen 40, the control unit 100A specifies the position of the stylus pen 40, specifies the line in the list at the position tapped with the stylus pen 40, and acquires the position information associated with the line that was tapped with the stylus pen 40 (step SA1).

The control unit 100A, upon acquiring the position information, judges whether another display apparatus 10 that is coordinated with the display apparatus 10A is connected in accordance with Bluetooth communication standards (whether there is another display apparatus connected to the display apparatus 10A in accordance with Bluetooth communication standards). Note that “connected” refers to a state where the display apparatuses are paired via Bluetooth.

If another display apparatus 10 that is coordinated with the display apparatus 10A is connected in accordance with Bluetooth communication standards (YES at step SA2), the control unit 100A controls the communication unit 108A to transmit the filename included in the position information acquired at step SA1 to the other display apparatus 10 (step SA3). For example, if the display apparatus 10A and the display apparatus 10B are connected, the control unit 100A controls the communication unit 108A to transmit the filename to the display apparatus 10B.

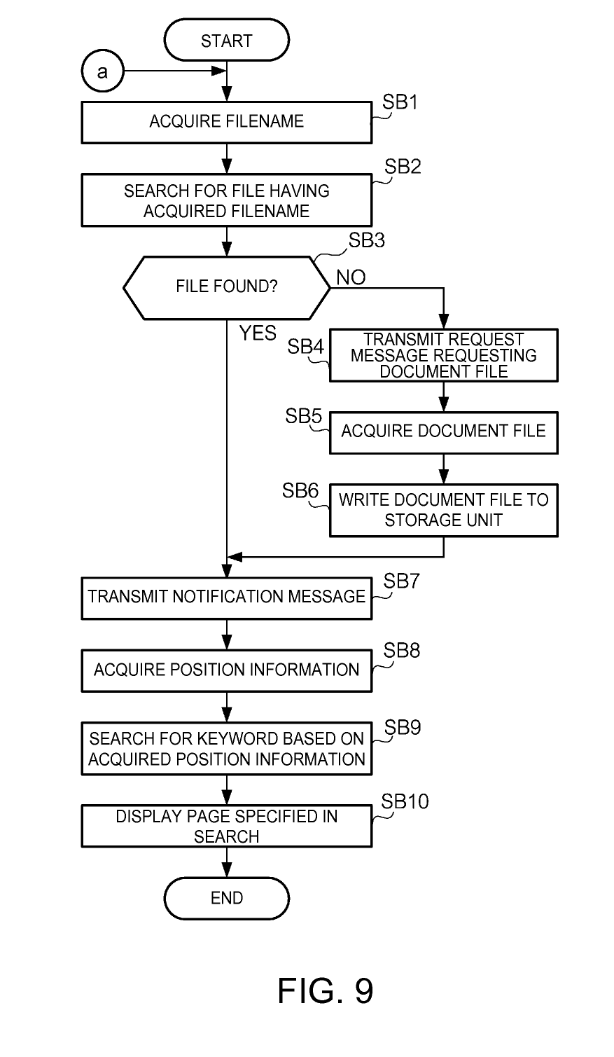

FIG. 9 is a flowchart showing the flow of processing that is performed by a display apparatus 10 to which a filename is transmitted. When the communication unit 108B receives a filename transmitted from the display apparatus 10A, the control unit 100B acquires the filename received by the communication unit 108B (step SB1). The control unit 100B searches the storage unit 102B (step SB2), and judges whether a document file having the acquired filename is stored in the storage unit 102B.

If a document file having the filename acquired at step SB1 is already stored in the storage unit 102B (YES at step SB3), the control unit 100B shifts the flow of processing to step SB7, and controls the communication unit 108B to transmit a notification message notifying that the document file has been acquired to the display apparatus 10A (step SB7).

If the communication unit 108A receives a notification message transmitted from the display apparatus 10B (YES at step SA7), the control unit 100A acquires the notification message received by the communication unit 108A (step SA8). The control unit 100A (transmission unit 153), having acquired the notification message, controls the communication unit 108A to transmit the position information acquired at step SA1 to the display apparatus 10B (step SA9).

When the communication unit 108B receives position information transmitted from the display apparatus 10A, the control unit 100B (reception unit 154) acquires the position information received by the communication unit 108B (step SB8). The control unit 100B (display control unit 152) searches for a keyword based on the acquired position information (step SB9).

Specifically, the control unit 100B (display control unit 152) specifies, in the document corresponding to the document file having the filename included in the acquired position information, the page having the page number included in the position information, and searches the specified page for the keyword included in the position information. Also, the control unit 100B (display control unit 152) specifies the keyword that is specified by the hit number included in the position information, from among the hits for the keyword on the specified page.

When the keyword search and specification of the keyword that is specified by the hit number have ended, the control unit 100B (display control unit 152), performs processing for displaying the specified page (step SB10). Here, the control unit 100B writes the data of an image in which the keyword that is specified by the hit number among the hits for the keyword in the search is enclosed by a rectangle drawn with a solid line and in which hits for the keyword other than the keyword that is specified by the hit number are enclosed by a rectangle drawn with a dotted line to the buffer 105B. When the drive unit 106B drives the display unit 107B based on the data written to the buffer 105B, an image in which the keyword that is specified by the hit number among the hits for the keyword in the search is enclosed by a rectangle drawn with a solid line and in which hits for the keyword other than the keyword that is specified by the hit number are enclosed by a rectangle drawn with a dotted line is displayed on the display unit 107B, as illustrated in FIG. 10.

Note that if a document file having the filename acquired at step SB2 is not stored in the storage unit 102 (NO at step SB3), the control unit 100B controls the communication unit 108B to transmit a request message requesting the document file having the acquired filename to the display apparatus 10A (step SB4).

If the communication unit 108A receives a request message transmitted from the display apparatus 10B (YES at step SA4), the control unit 100A acquires the request message received by the communication unit 108A (step SA5). The control unit 100A, having acquired the request message, acquires the document file having the filename transmitted to the display apparatus 10B from the storage unit 102A, and controls the communication unit 108A to transmit the acquired document file to the display apparatus 10B (step SA6).

When the communication unit 108B receives a document file transmitted from the display apparatus 10A, the control unit 100B acquires the document file received by the communication unit 108B (step SB5). The control unit 100B writes the acquired document file to the storage unit 102B (step SB6). When writing of the document file to the storage unit 102B has ended, the control unit 100B controls the communication unit 108B to transmit a notification message notifying that the document file was acquired to the display apparatus 10A (step SB7). Since the operations from step SB7 are the same as in the case where it is judged YES at step SB3, description thereof will be omitted.

If there is not a display apparatus 10 that is connected (NO at step SA2), the control unit 100A searches for the keyword, based on the acquired position information (step SA10). Specifically, the control unit 100A searches the storage unit 102A for the document file having the filename included in the position information. Upon finding the document file, the control unit 100A specifies, in the document corresponding to the found document file, the page having the page number included in the position information, and searches the specified page for the keyword included in the position information. Also, the control unit 100A specifies the keyword that is specified by the hit number included in the position information, from among the hits for the keyword on the specified page.

When the keyword search and specification of the keyword that is specified by the hit number have ended, the control unit 100A performs processing for displaying the specified page (step SA11). The control unit 100A writes the data of an image in which the keyword that is specified by the hit number among the hits for the keyword in the search is enclosed by a rectangle drawn with a solid line and in which hits for the keyword other than the keyword that is specified by the hit number are enclosed by a rectangle drawn with a dotted line to the buffer 105A. When the drive unit 106A drives the display unit 107A based on the data written to the buffer 105A, an image in which the keyword that is specified by the hit number among the hits for the keyword in the search is enclosed by a rectangle drawn with a solid line and in which hits for the keyword other than the keyword that is specified by the hit number are enclosed by a rectangle drawn with a dotted line is displayed on the display unit 107A, as illustrated in FIG. 10.

Thus, in the first embodiment, when a keyword search is performed on a document in the display apparatus 10A and the user selects a line from the lines of the list of search results for the keyword, the page corresponding to the selected search result is displayed in the display apparatus 10B connected to the display apparatus 10A, and hits for the keyword are clearly identified on the displayed page. Since pages containing the keyword are displayed in one display apparatus 10 while the list of search results is being displayed in another display apparatus 10, and the keyword is clearly identified, the user can readily grasp the positions of the keyword in the document.

Also, since the page corresponding to the selected search result is displayed and hits for the keyword are clearly identified on the displayed page simply by transmitting position information from the display apparatus 10A to the display apparatus 10B, the amount of communication can be suppressed, compared with a configuration in which image data is transmitted from the display apparatus 10A to the display apparatus 10B.

Also, because the page number is included in the position information that is transmitted, and the display apparatus 10 that receives the position information searches for the page having the page number included to the position information, the search processing is performed quickly in the display apparatus that receives the position information. Since the position information also includes the hit number, the keyword in the line tapped in the list by the user can be specified by the display apparatus 10 that receives the position information, and the specified keyword can be displayed in a clearly identifiable manner.

In other words, search results can be quickly display in the display apparatus 10B, while reducing the amount of communication between the display apparatus 10A and the display apparatus 10B.

Note that, in the first embodiment, since the display apparatus 10A and the display apparatus 10B have the same configuration, the display apparatus 10B is capable of performing the abovementioned operations of the display apparatus 10A, and the display apparatus 10A is capable of performing the abovementioned operations of the display apparatus 10B. In other words, the search can be performed by the display apparatus 10B, and the display of pages in which the keyword appears can be performed by the display apparatus 10A.

Also, in the abovementioned exemplary operations, position information is transmitted from the display apparatus 10A to the display apparatus 10B after the document file has been transmitted from the display apparatus 10A to the display apparatus 10B, but the position information may be transmitted when the document file is transmitted.

Exemplary Operations when Character Formatting and Handwritten Lines in a Document are Found in a Search

Next, exemplary operations in the case where character formatting and handwritten lines (i.e., objects) added to a document by a user operation are found in a search will be described. When the user taps the icon T8 with the stylus pen 40, the control unit 100A searches the document file of the displayed document for character formatting data and handwritten line data with character formatting and handwritten lines as search keys, and specifies pages having character formatting and handwritten lines.

The control unit 100A (list generation unit 151), upon ending the search for character formatting and handwritten lines, generates a list of search results, generates image data based on the list, and writes the generated image data to the buffer 105A. When the drive unit 106A drives the display unit 107A based on the data written to the buffer 105, a list of search results is displayed on the display unit 107A. Since character formatting and handwritten lines are examples of objects in a document, the list of search results can be referred to as an example of a list of search results for objects.

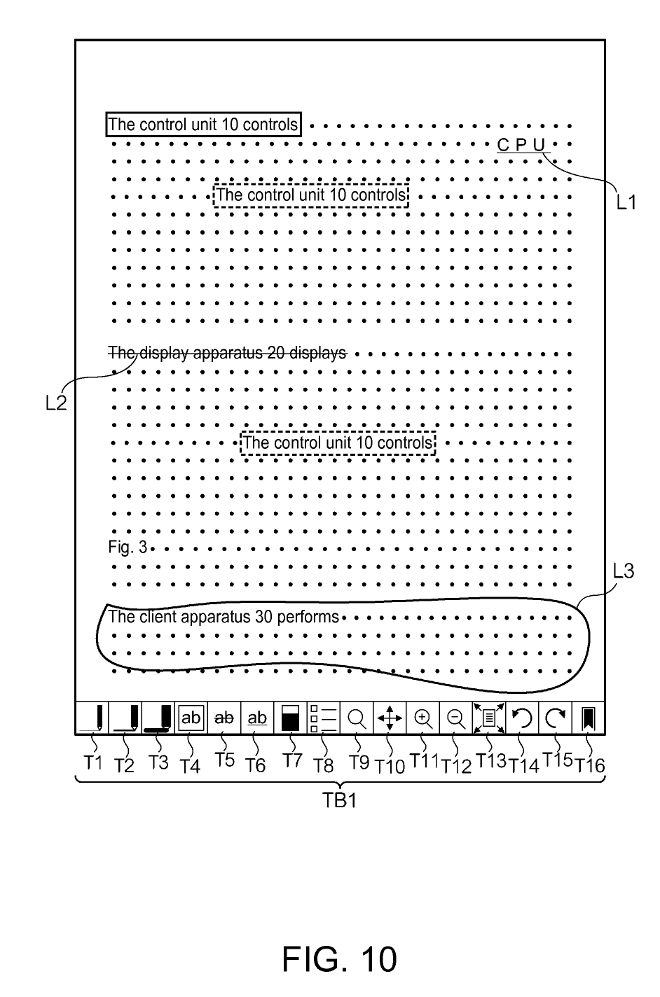

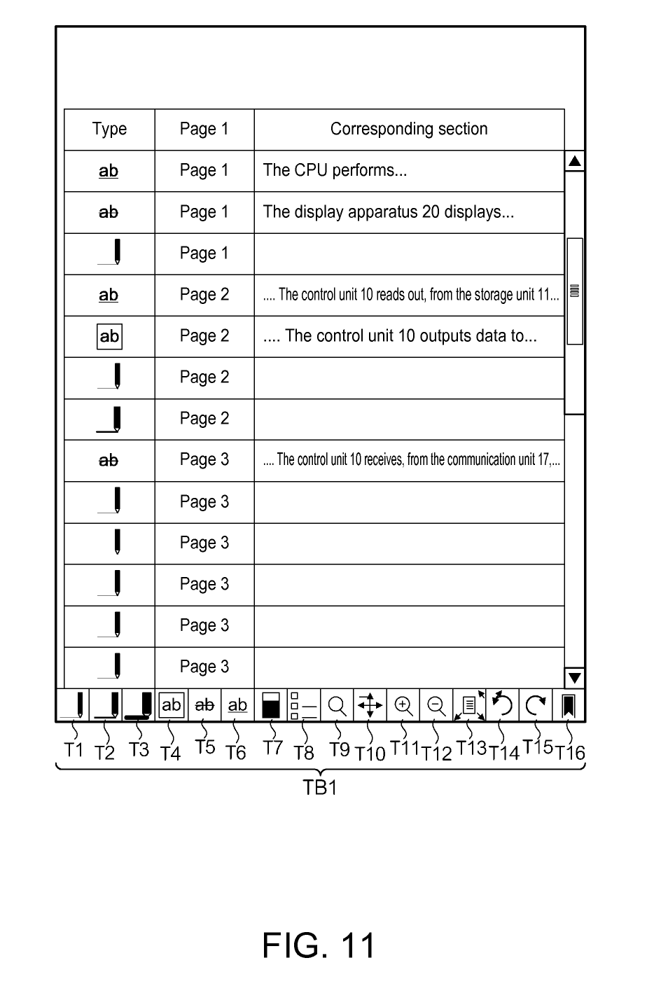

In the case where the underline L1, the strikethrough L2, and the handwritten line L3 appear on the first page of the document as illustrated in FIG. 6, the types of character formatting and handwritten lines found in the search and the page numbers of the pages on which the character formatting and handwritten lines found in the search appear are displayed, as illustrated in FIG. 11. With regard to character formatting, the character string that has undergone character formatting is displayed as the section corresponding to the character formatting. Note that, in FIG. 11, the first line of search results represents the search result of the underline L1 shown in FIG. 10, the second line of search results represents the search result of the strikethrough L2 shown in FIG. 10, and the third line of search results represents the search result of the handwritten line L3 shown in FIG. 10.

The control unit 100A associates position information with the display area of each line of the displayed list. This position information includes the filename of the document file that was searched and the page number included in the line. This pairing of a filename and a page number shows the position of character formatting or the position of a handwritten line in the document.

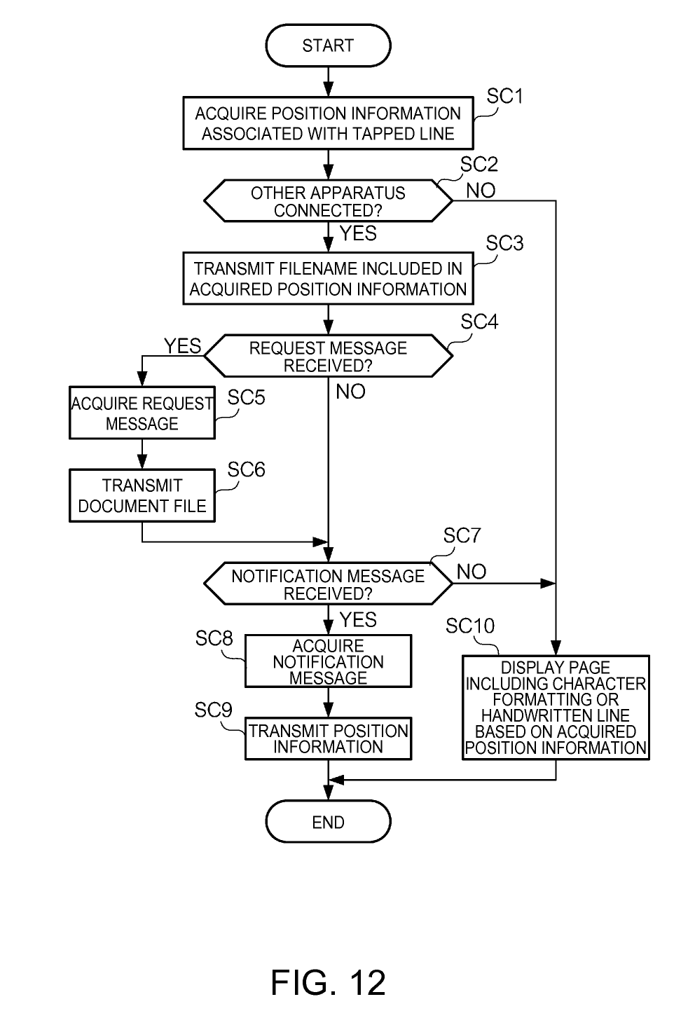

FIG. 12 is a flowchart showing the flow of processing that is performed by the control unit 100 when one of the lines of the list of search results for character formatting and handwritten lines is selected. When, in a state where a list of search results is displayed on the display unit 107A, the user taps one of the lines of the list with the stylus pen 40, the control unit 100A acquires the position information associated with the line touched by the stylus pen 40 (step SC1).

When acquisition of position information has ended, the control unit 100A judges whether another display apparatus 10 that is coordinated with the display apparatus 10A is connected in accordance with Bluetooth communication standards (whether there is another display apparatus connected to the display apparatus 10A in accordance with Bluetooth communication standards).

If another display apparatus 10 that is coordinated with the display apparatus 10A is connected in accordance with Bluetooth communication standards (YES at step SC2), the control unit 100A controls the communication unit 108A to transmit the filename included in the position information acquired at step SC1 to the other display apparatus 10 (step SC3). For example, in the case where the display apparatus 10A and the display apparatus 10B are connected, the control unit 100A controls the communication unit 108A to transmit the filename to the display apparatus 10B.

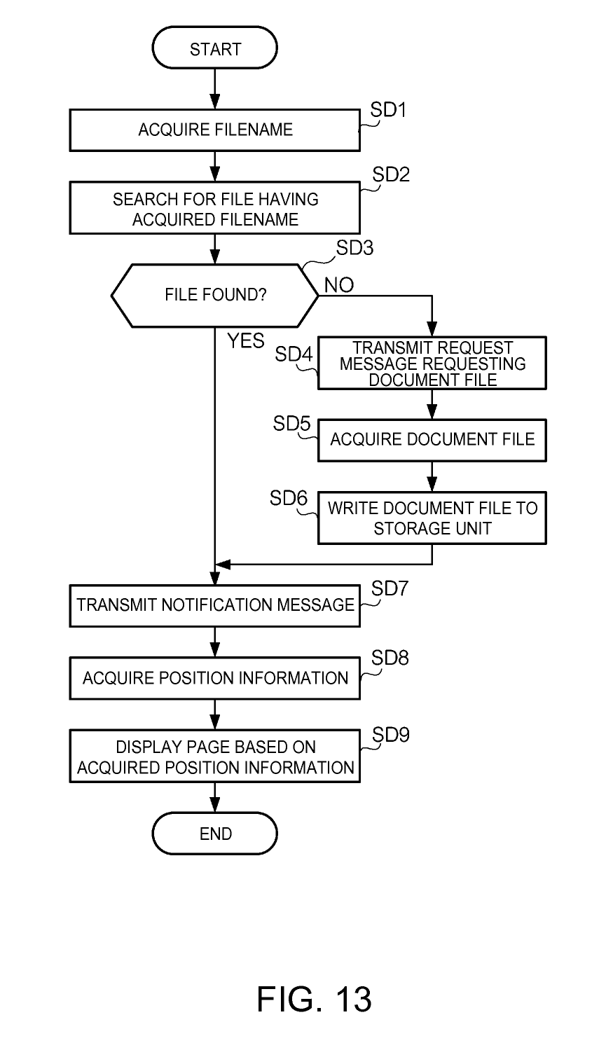

FIG. 13 is a flowchart showing the flow of processing that is performed by a display apparatus 10 to which a filename is transmitted. When the communication unit 108B receives a filename transmitted from the display apparatus 10A, the control unit 100B acquires the filename received by the communication unit 108B (step SD1). The control unit 100B searches the storage unit 102B (step SD2), and judges whether a document file having the acquired filename is stored in the storage unit 102B.

If a document file having the filename acquired at step SD1 is already stored in the storage unit 102B (YES at step SD3), the control unit 100B shifts the flow of processing to step SD7, and controls the communication unit 108B to transmit a notification message to the display apparatus 10A.

If the communication unit 108A receives a notification message transmitted from the display apparatus 10B (YES at step SC7), the control unit 100A acquires the notification message received by the communication unit 108A (step SC8). The control unit 100A (transmission unit 153), having acquired the notification message, controls the communication unit 108A to transmit the position information acquired at step SC1 to the display apparatus 10B (step SC9).

When the communication unit 108B receives position information transmitted from the display apparatus 10A, the control unit 100B (reception unit 154) acquires the position information received by the communication unit 108B (step SD8). The control unit 100B (display control unit 152) displays a page, based on the acquired position information (step SD9). Specifically, the control unit 100B (display control unit 152) performs processing for specifying, in the document corresponding to the document file having the filename included in the acquired position information, the page having the page number included in the position information, and displaying the specified page. Here, the control unit 100B writes the image data of the specified page to the buffer 105B. When the drive unit 106B drives the display unit 107B based on the data written to the buffer 105B, the first page on which the underline L1 appears in the document that was searched is displayed on the display unit 107B, as illustrated in FIG. 10.

Note that if a document file having the acquired filename is not stored in the storage unit 102B (NO at step SD3), the control unit 100B controls the communication unit 108B to transmit a request message requesting the document file having the acquired filename to the display apparatus 10A (step SD4).

If the communication unit 108A receives a request message transmitted from the display apparatus 10B (YES at step SC4), the control unit 100A acquires the request message received by the communication unit 108A (step SC5). The control unit 100A, having acquired the request message, acquires the document file having the filename transmitted to the display apparatus 10B from the storage unit 102A, and controls the communication unit 108A to transmit the acquired document file to the display apparatus 10B (step SC6).

When the communication unit 108B receives a document file transmitted from the display apparatus 10A, the control unit 100B acquires the document file received by the communication unit 108B (step SD5). The control unit 100B writes the acquired document file to the storage unit 102B (step SD6). When writing of the document file to the storage unit 102B has ended, the control unit 100B controls the communication unit 108B to transmit a notification message notifying that the document file was acquired to the display apparatus 10A (step SD7). Since the operations from step SD7 are the same as in the case where it is judged YES at step SD3, description thereof will be omitted.

If there is not a display apparatus 10 that is connected (NO at step SC2), the control unit 100A displays the page containing the character formatting or the handwritten line, based on the acquired position information (step SC10). Specifically, the control unit 100A specifies, in the document corresponding to the document file having the filename included in the position information, the page having the page number included in the position information, and writes the data of an image of the specified page to the buffer 105A. When the drive unit 106A drives the display unit 107A based on the data written to the buffer 105A, an image of the specified page is displayed on the display unit 107A. For example, in the case where the user selects the first line of the list shown in FIG. 11, the first page on which the underline L1 appears in the document that was searched is displayed on the display unit 107A, as illustrated in FIG. 10.

Thus, in the first embodiment, when a document is searched for character formatting and handwritten lines in the display apparatus 10A and the user selects a line from the lines of the list of search results, the page corresponding to the selected search result is displayed in the display apparatus 10B connected to the display apparatus 10A, and character formatting and handwritten lines found in the search are displayed on the displayed page. Since pages containing character formatting or handwritten lines are displayed in one display apparatus 10 while the list of search results is being displayed in another display apparatus 10, the user can readily grasp the positions of character formatting and handwritten lines in the document.

Also, since the page corresponding to the selected search result is displayed, and objects found in the search are displayed on the displayed page simply by transmitting position information from the display apparatus 10A to the display apparatus 10B, the amount of communication can be suppressed, compared with a configuration in which image data is transmitted from the display apparatus 10A to the display apparatus 10B.

Also, because the page number is included in the position information that is transmitted, and the display apparatus 10 that receives the position information displays the page having the page number included in the position information, the search processing in the display apparatus 10 that receives the position information is performed quickly.

In other words, search results can be displayed quickly in the display apparatus 10B, while reducing the amount of communication between the display apparatus 10A and the display apparatus 10B.

Note that, in the first embodiment, since the display apparatus 10A and the display apparatus 10B have the same configuration, the display apparatus 10B is capable of performing the abovementioned operations of the display apparatus 10A, and the display apparatus 10A is capable of performing the abovementioned operations of the display apparatus 10B. In other words, the search can be performed by the display apparatus 10B, and the display of pages in which character formatting and handwritten lines appear can be performed by the display apparatus 10A.

Also, in the abovementioned exemplary operations, position information is transmitted from the display apparatus 10A to the display apparatus 10B after the document file has been transmitted from the display apparatus 10A to the display apparatus 10B, but the position information may be transmitted when the document file is transmitted.

Exemplary Operations when Three Display Devices 10 are Coordinated

Next, exemplary operations in the case where three display apparatuses 10 are coordinated will be described. Note that, in the following description, a state in which the display apparatuses 10A to 10C are connected to each other in accordance with Bluetooth communication standards will be assumed.

When the user performs an operation for searching for a character string in a document displayed in the display apparatus 10A, a list of search results is displayed on the display unit 107A, as described above. When one of the lines of the displayed list is tapped with the stylus pen 40, the control unit 100A acquires the position information associated with the line that was tapped with the stylus pen 40 (step SA1). When acquisition of the position information has ended, the control unit 100A judges whether another display apparatus 10 that is coordinated with the display apparatus 10A is connected in accordance with Bluetooth communication standards. If there are two or more display apparatuses 10 that are connected, the control unit 100A controls the communication unit 108A to transmit the filename included in the position information acquired at step SA1 to the connected display apparatuses 10 (step SA3). For example, in the case where the display apparatus 10B and the display apparatus 10C are connected to the display apparatus 10A, the filename included in the position information is transmitted to the display apparatus 10B and the display apparatus 10C.

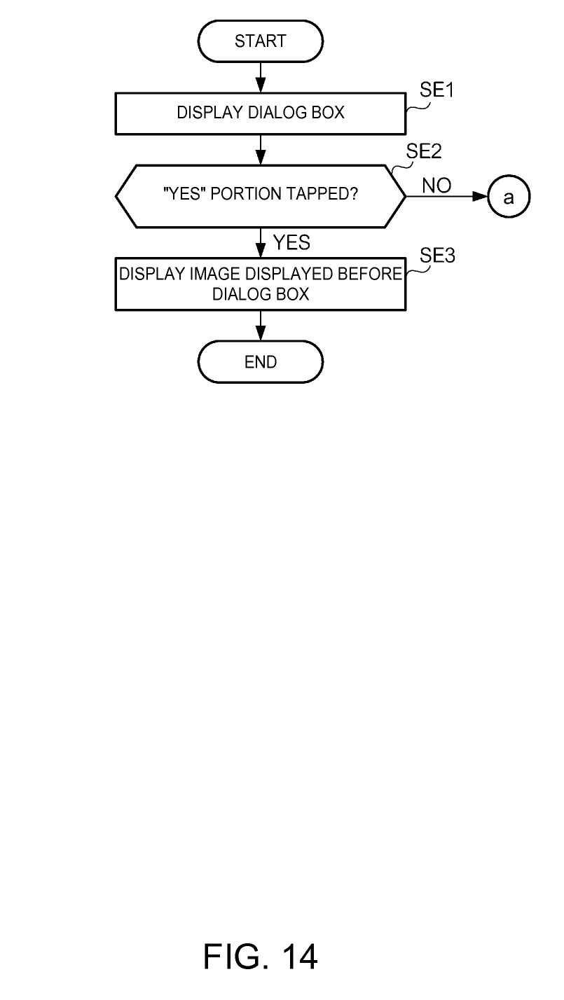

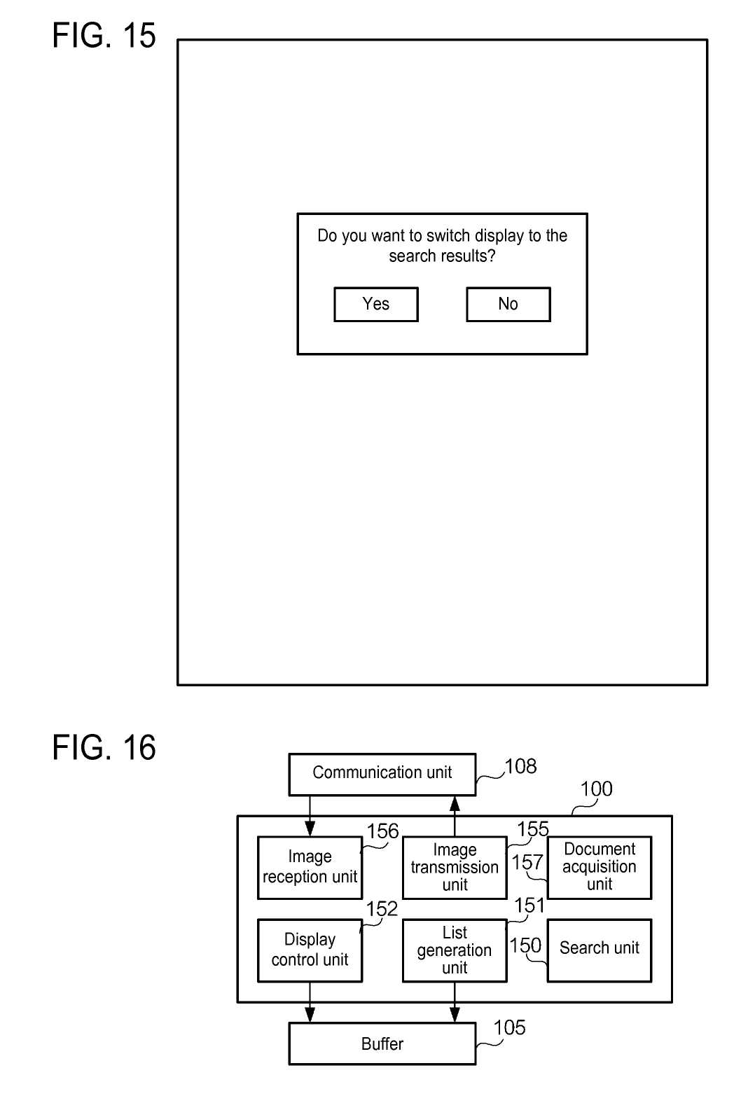

FIG. 14 is a flowchart showing the flow of processing that is performed by a display apparatus 10 to which a filename is transmitted, when connected to a plurality of other display apparatuses 10. When the display apparatus 10B is connected to the display apparatuses 10A and 10C, the control unit 100B, in the case where the communication unit 108B receives a filename transmitted from the display apparatus 10A, writes the data of an image of a dialog box for querying the user as to whether to display search results to the buffer 105B. When the drive unit 106B drives the display unit 107B based on the data written to the buffer 105B, an image of a dialog box is displayed on the display unit 107B, as illustrated in FIG. 15. The dialog box illustrated in FIG. 15 is also displayed in the display apparatus 10C to which the filename was transmitted from the display apparatus 10A, similarly to the display apparatus 10B (step SE1).

When, in the state where the dialog box shown in FIG. 15 is displayed on the display unit 107B, the user taps the “yes” portion of the dialog box with the stylus pen 40 (YES at step SE2), the control unit 100B shifts the flow of processing to step SB1. The operations performed after shifting the flow of processing to step SB1 are the same as the abovementioned exemplary operations, and an image in which the keyword that is specified by the hit number among the hits for the keyword in the search is enclosed by a rectangle drawn with a solid line and in which hits for the keyword other than the keyword that is specified by the hit number are enclosed by a rectangle drawn with a dotted line is displayed in the display apparatus 10B.

When, in a state in which the dialog box shown in FIG. 15 is displayed in the display apparatus 10C, the user taps the “no” portion of the dialog box with the stylus pen 40, the control unit 100C writes the data of the image that was displayed prior to the dialog box to the buffer 105C. When the drive unit 106C drives the display unit 107C based on the data written to the buffer 105C, the dialog box is removed and the image that was displayed prior to the dialog box is displayed on the display unit 107C (step SE3).

Note that in the case where the user taps the “no” portion of the dialog box with the stylus pen 40 in the display apparatus 10B, the dialog box is removed and the image that was displayed prior to the dialog box is displayed on the display unit 107B, similarly to the abovementioned display apparatus 10C. Also, in the case where the user taps the “yes” portion of the dialog box with the stylus pen 40 in the display apparatus 10C, an image in which the keyword that is specified by the hit number among the hits for the keyword in the search is enclosed by a rectangle drawn with a solid line and in which hits for the keyword other than the keyword that is specified by the hit number are enclosed by a rectangle drawn with a dotted line is displayed, similarly to the abovementioned display apparatus 10B.

Thus, according to the present embodiment, it becomes possible to display pages relating to selected search results on a plurality of display apparatuses 10. For example, in the case where a character string search is performed in the display apparatus 10A, it also becomes possible to clearly identify the keyword on the first page of the document in the display apparatus 10B, and to clearly identify the keyword on the third page of the document in the display apparatus 10C. Note that, in the abovementioned exemplary operations, the case where three display apparatuses 10A to 10C are coordinated was described, but the number of display apparatuses 10 that are coordinated is not limited to three, and four or more display apparatuses 10 may be coordinated. Also, in the abovementioned exemplary operations, a character string search was given as an example, but even in the case where a search for character formatting and handwritten lines is performed, a configuration can be adopted in which three or more display apparatuses 10 are coordinated, and pages that contain character formatting or handwritten lines found in the search are displayed on a plurality of display apparatuses 10, similarly to the character string search.

### Second Embodiment

Next, a second embodiment of the invention will be described. The display system 1 according to the second embodiment of the invention has display apparatuses 10A to 10C, like the first embodiment, and the hardware configuration of the display apparatuses 10A to 10C is the same as the first embodiment. However, the programs that are executed by the display apparatuses 10 differs, and the operations that are performed when displaying character strings, character formatting or handwritten lines found in a search differs from the first embodiment. Hereinafter, description of configuration that is the same as the first embodiment will be omitted, and differences from the first embodiment will be described.

FIG. 16 is a block diagram showing the configuration of functions that are realized in the control unit 100 according to the second embodiment. An image transmission unit 155 generates data indicating an image of a page that is specified by position information in a document, and controls the communication unit 108 to transmit the generated image data to another display apparatus 10. An image reception unit 156 controls the communication unit 108 and receives image data transmitted by the image transmission unit 155 of another display apparatus 10. A display control unit 152 according to the second embodiment writes the data received by the image reception unit 156 to the buffer 105.

### Exemplary Operations of Second Embodiment

Next, exemplary operations of the second embodiment will be described with reference to the drawings. Note that, hereinafter, exemplary operations will be described assuming the case where the display apparatus 10A and the display apparatus 10B are connected to each other in accordance with Bluetooth communication standards.

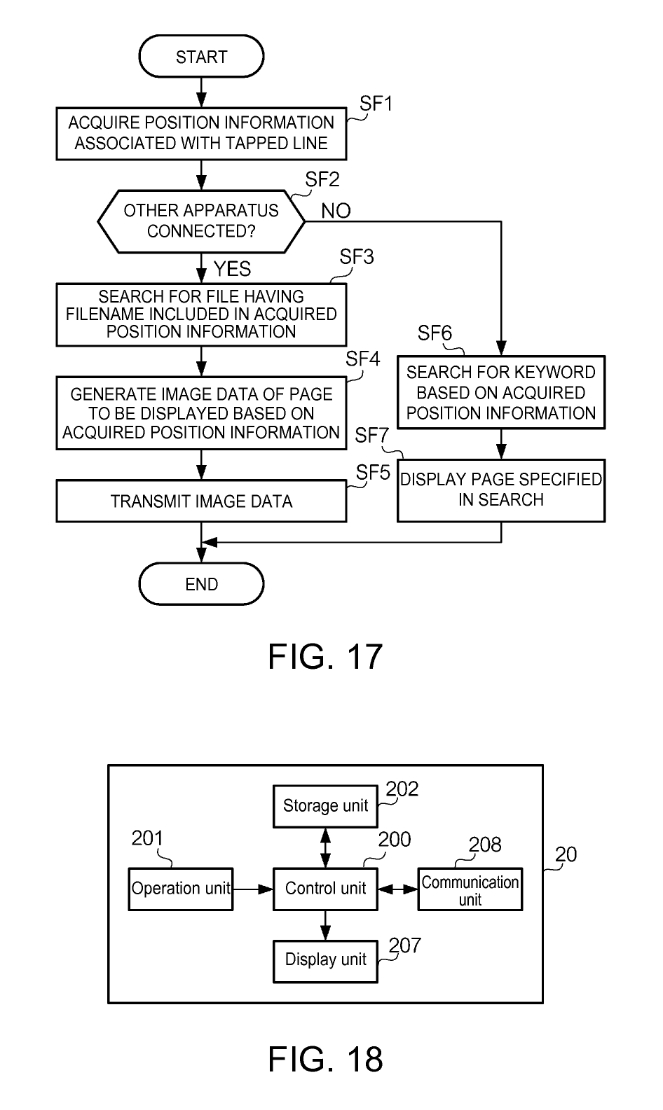

When the user performs an operation for searching for a character string in a document displayed in the display apparatus 10A, a list of search results is displayed on the display unit 107A similarly to the first embodiment. FIG. 17 is a flowchart showing the flow of processing that is performed by the control unit 100 when one of the lines of the list of search results for a keyword is selected. When one of the lines of the displayed list is tapped with the stylus pen 40, the control unit 100A acquires the position information associated with the line that was tapped with the stylus pen 40 (step SF1). When acquisition of the position information has ended, the control unit 100A judges whether another display apparatus 10 that is coordinated with the display apparatus 10A is connected in accordance with Bluetooth communication standards. If there is a connected apparatus (YES at step SF2), the control unit 100A searches the storage unit 102A for a document file having the filename included in the position information (step SF3).

When the document file is found, the control unit 100A performs processing for specifying, in the document corresponding to the document file that is found, the page having the page number included in the position information and generating the data of an image of the specified page (step SF4). Here, the control unit 100A specifies, in the document corresponding to the found document file, the page having the page number included in the position information, and searches the specified page for the keyword included in the position information. Also, the control unit 100A specifies the keyword that is specified by the hit number included in the position information from among the hits for the keyword on the specified page. When the keyword search and specification of the keyword that is specified by the hit number has ended, the control unit 100A generates the data of an image in which the keyword that is specified by the hit number among the hits for the keyword in the search is enclosed by a rectangle drawn with a solid line and in which hits for the keyword other than the keyword that is specified by the hit number are enclosed by a rectangle drawn with a dotted line. The control unit 100A (image transmission unit 155) controls the communication unit 108A to transmit the generated image data to the display apparatus 10B (step SF5).

When the communication unit 108B receives the data transmitted from the display apparatus 10A, the control unit 100B (image reception unit 156) acquires the data received by the communication unit 108B. The control unit 100B (display control unit 152) writes the data received by the communication unit 108B to the buffer 105B. When the drive unit 106B drives the display unit 107B based on the data written to the buffer 105B, an image in which the keyword that is specified by the hit number among the hits for the keyword in the search is enclosed by a rectangle drawn with a solid line and in which hits for the keyword other than the keyword that is specified by the hit number are enclosed by a rectangle drawn with a dotted line is displayed, as illustrated in FIG. 10.

Note that the control unit 100A executes the processing of steps SF6 and SF7 if it is judged “NO” at step SF2. The processing of step SF6 is the same as step SA10, and the processing of step SF7 is the same as step SA11. Thus, if it is judged “NO” at step SF2, an image in which the keyword that is specified by the hit number among the hits for the keyword in the search is enclosed by a rectangle drawn with a solid line and in which hits for the keyword other than the keyword that is specified by the hit number are enclosed by a rectangle drawn with a dotted line is displayed on the display unit 107A.

Thus, in the second embodiment, similarly to the first embodiment, when a keyword search is performed on a document in the display apparatus 10A and the user makes a selection from the list of search results for the keyword, the page corresponding to the selected search result is displayed in the display apparatus 10B connected to the display apparatus 10A, and hits for the keyword are clearly identified on the displayed page. Since pages on which the keyword appears are displayed and the keyword is clearly identified on one of the display apparatuses 10 while the list of search results is being displayed in the other display apparatus 10, the user can readily grasp the position of the keyword in the document.

Note that although a character string search was given as an example in the abovementioned exemplary operations, when, in the second embodiment, a character formatting search or a handwritten line search is performed by the display apparatus 10A and the user selects one of the search results from the list of search results, the data of an image of the page corresponding to the selected search result is transmitted to the display apparatus 10B. An image corresponding to the transmitted data is displayed in the display apparatus 10B, and the character formatting or handwritten line is displayed on the displayed page.

### Third Embodiment

Next, a third embodiment of the invention will be described. The third embodiment of the invention is a configuration for realizing the functions of the display apparatus 10A and the display apparatus 10B in a single computer apparatus such as personal computer apparatus.

FIG. 18 is a block diagram showing the hardware configuration of a computer apparatus 20 that realizes the functions of the display apparatus 10A and the display apparatus 10B in the third embodiment.

A control unit 200 is provided with a CPU, a RAM and the like, and executes computer programs stored in a storage unit 202. When the control unit 200 executes the program of an operating system stored in the storage unit 202, the operating system is realized in the computer apparatus 20.

A display unit 207 has a display apparatus (e.g., liquid crystal display), and displays images of user interfaces for operating the computer apparatus 20, and the like. An operation unit 201 has a keyboard and a mouse for operating the computer apparatus 20. A communication unit 208 is a communication interface that performs data communication via a computer network. The storage unit 202 has a nonvolatile memory, and stores the computer program that realizes the operating system, and an application program that realizes the functions of the display apparatuses 10A and 10B.

### Functional Blocks

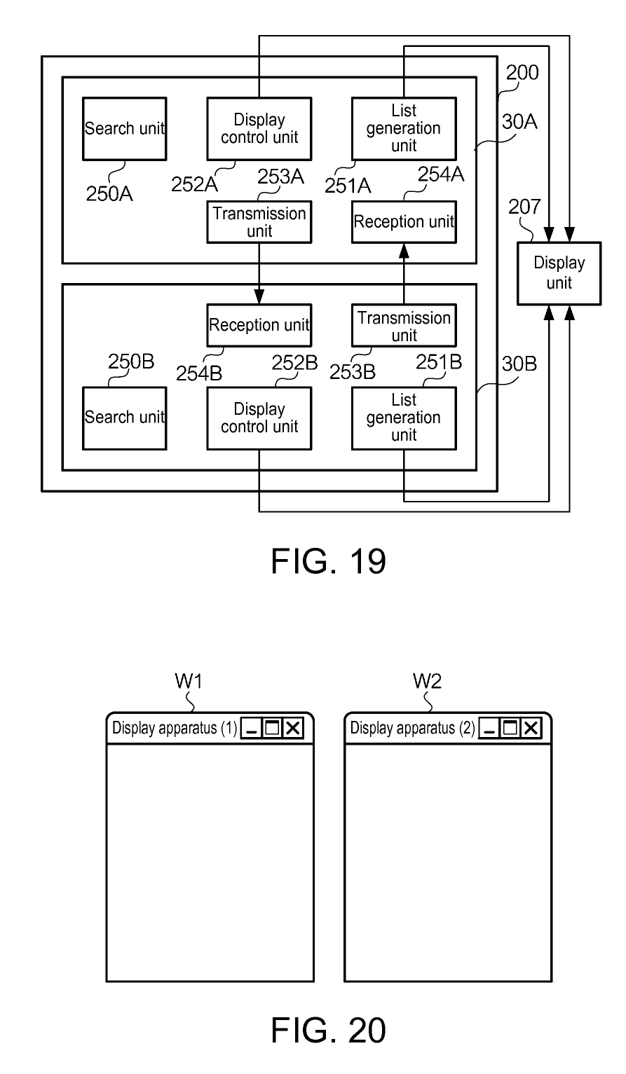

FIG. 19 is a block diagram showing the configuration of functions that are realized in the computer apparatus 20. Virtual display apparatuses 30A and 30B are emulators that emulate the functions of the display apparatuses 10. A search unit 250A searches a document in a specified document file with a search key designated by the user. A list generation unit 251A generates a list of objects in a document, generates an image of the list, and controls the display unit 207 such that the image of the list that was generated is displayed in a window W1 corresponding to the virtual display apparatus 30A. A transmission unit 253A transmits position information on the position of an object selected from the list of objects displayed in the window W1 to the virtual display apparatus 30B. A reception unit 254A receives position information transmitted from the virtual display apparatus 30B. A display control unit 252A specifies a position in the document based on the position information received by the reception unit 254A, and controls the display unit 207 such that an image of the portion at the specified position in the document is displayed in the window W1.

A search unit 250B searches the document in the specified document file with a search key designated by the user. A list generation unit 251B generates a list of objects in the document, generates an image of the list, and controls the display unit 207 such that the image of the list that was generated is displayed in a window W2 corresponding to the virtual display apparatus 30B. A transmission unit 253B transmits position information on the position of an object selected from the list of objects displayed in the window W2 to the virtual display apparatus 30A. A reception unit 254B receives position information transmitted from the virtual display apparatus 30A. A display control unit 252B specifies a position in the document based on the position information received by the reception unit 254B, and controls the display unit 207 such that an image of the portion at the specified position in the document is displayed in the window W2.

### Exemplary Operations of Third Embodiment

Next, exemplary operations of the third embodiment will be described. First, when an operation of executing the application program that realizes the display apparatuses 10A and 10B is performed on the operation unit 201, the control unit 200 executes the application program stored in the storage unit 202. When the control unit 200 executes the application program, the virtual display apparatus 30A corresponding to the display apparatus 10A and the virtual display apparatus 30B corresponding to the display apparatus 10B are realized in the computer apparatus 20.

The virtual display apparatus 30A controls the display unit 207 such that the window W1 serving as a display unit of the virtual display apparatus 30A is displayed, as illustrated in FIG. 20, and the virtual display apparatus 30B controls the display unit 207 such that the window W2 serving as a display unit of the virtual display apparatus 30B is displayed, as illustrated in FIG. 20.

Next, when the user performs an operation for selecting the window W1 with a mouse, the window W1 enters an active state, and the virtual display apparatus 30A enters a state of receiving user operations. When the user performs an operation for opening a document file stored in the storage unit 202 in the window W1, the virtual display apparatus 30A acquires the document file from the storage unit 202. When the virtual display apparatus 30A controls the display unit 207 in accordance with the acquired document file, a document corresponding to the document file is displayed in the window W1. Note that a tool bar TB1 for performing various processing on a document is also displayed in the window W1, similarly to the display apparatus 10 of the first embodiment.

When the user performs an operation for clicking on an icon T9 of the displayed tool bar TB1 with the mouse, the virtual display apparatus 30A controls the display unit 207 such that the tool bar TB2 is displayed in the window W1. When the user performs an operation for clicking a search button on the tool bar TB2 with the mouse, after inputting a character string in the text box BX of the tool bar TB2 with the keyboard, the virtual display apparatus 30A searches the document file of the document displayed in the window W1 with the character string in the text box BX as the keyword. In the keyword search, the virtual display apparatus 30A specifies a page in which the keyword appears, and gives a hit number to the keyword that appears on the specified page.

The virtual display apparatus 30A (list generation unit 251A), upon ending the keyword search, controls the display unit 207 such that a list of search results is displayed in the window W1. The list of search results is displayed in the window W1, similarly to the display apparatus 10 of the first embodiment.

Note that the virtual display apparatus 30A associates position information with the display area of each line of the displayed list. The position information includes the filename of the document file that was searched, the page number included in the line, the hit number of the keyword included in the line, and the keyword.

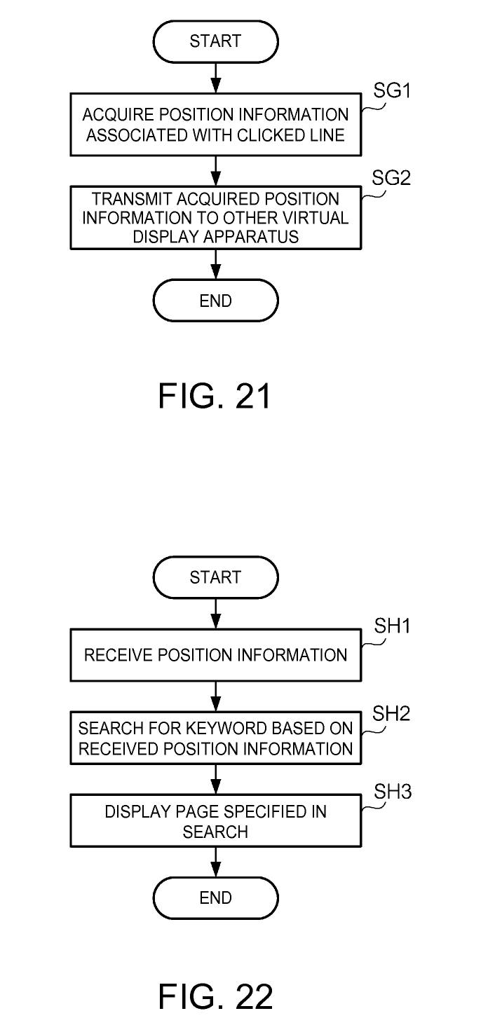

FIG. 21 is a flowchart showing the flow of processing when one of the lines of a list of search results for a keyword is selected in the virtual display apparatus 30A. When, in a state where a list of search results is displayed in the window W1, the user performs a mouse operation clicking one of the lines of the list, the virtual display apparatus 30A acquires the position information associated with the line at the position of the mouse cursor (step SG1). The virtual display apparatus 30A (transmission unit 253A) transmits the acquired position information to the virtual display apparatus 30B (step SG2).

FIG. 22 is a flowchart showing the flow of processing that is performed by the virtual display apparatus 30B to which the position information was transmitted. The virtual display apparatus 30B (reception unit 254B) receives the position information transmitted from the virtual display apparatus 30A (step SH1), and searches for a keyword based on the received position information (step SH2). Specifically, the virtual display apparatus 30B searches the storage unit 202 for a document file having the filename included in the received position information. Upon finding the document file, the virtual display apparatus 30B specifies, in the document corresponding to the document file that was found, the page having the page number included in the received position information, and searches the specified page for the keyword included in the received position information. Also, the virtual display apparatus 30B specifies the keyword that is specified by the hit number included in the acquired position information from among the hits for the keyword on the specified page.

When the keyword search and specification of the keyword that is specified by the hit number have ended, the virtual display apparatus 30B (display control unit 252B) controls the display unit 207 such that an image in which the keyword that is specified by the hit number among the hits for the keyword in the search is enclosed by a rectangle drawn with a solid line and in which hits for the keyword other than the keyword that is specified by the hit number are enclosed by a rectangle drawn with a dotted line is displayed in the window W2 (step SH3). In the window W2, an image in which the keyword that is specified by the hit number among the hits for the keyword in the search is enclosed by a rectangle drawn with a solid line and in which hits for the keyword other than the keyword that is specified by the hit number are enclosed by a rectangle drawn with a dotted line is displayed, similarly to the display apparatus 10 of the first embodiment.

Note that, in the third embodiment, since the virtual display apparatus 30A and the virtual display apparatus 30B have the same configuration, the virtual display apparatus 30B is capable of performing the abovementioned operations of the virtual display apparatus 30A, and the virtual display apparatus 30A is capable of performing the abovementioned operations of the virtual display apparatus 30B. In other words, the search can be performed by the virtual display apparatus 30B, and the display of pages in which the keyword appears can be performed by the virtual display apparatus 30A.

Also, although a character string search was given as an example in the abovementioned exemplary operations, when, in the third embodiment, a character formatting search or a handwritten line search is performed by the virtual display apparatus 30A and the user selects one of search results from the list of search results, the data of an image of the page corresponding to the selected search result is displayed in the window W2 of the virtual display apparatus 30B, and the character formatting or handwritten line is displayed on the displayed page.

### Modifications

Although embodiments of the invention have been described above, the invention is not limited to the abovementioned embodiments and can be implemented in various other forms. For example, the invention may be implemented by modifying the abovementioned embodiments as follows. Note that the abovementioned embodiments and the following modifications may be respectively combined with each other.

In the abovementioned embodiments, the display apparatus 10 that performed the search is configured to check whether another display apparatus 10 has started communication, before transmitting the filename of a document file to the other display apparatus 10. Specifically, after acquiring position information at step SA1, the display apparatus 10A transmits, to the display apparatus 10B, a message querying whether the display apparatus 10B is currently performing communication. The display apparatus 10B, in the case of currently executing processing for performing communication with another display apparatus 10, transmits a message notifying that communication is currently being performed to the display apparatus 10A, and in the case of not currently performing communication, transmits a message notifying that communication is not currently being performed to the display apparatus 10A. The display apparatus 10A, having acquired a message from the display apparatus 10B, cancels communication processing with the display apparatus 10B in the case where a message notifying that communication is currently being performed is acquired, and executes the processing from step SA2 in the case where a message notifying that communication is not currently being performed is acquired. According to this configuration, a given display apparatus 10 does not start communication while the other display apparatus 10 is performing communication, thus avoiding an unexpected screen being displayed to the user.

In the abovementioned embodiments, the display apparatus 10 may be configured to transition to a power saving mode and stop power supply to the sensor 103, the detection unit 104, the buffer 105, the drive unit 106 and the display unit 107, in the case where an operation is not performed for longer than a predetermined time period. Also, the display apparatus 10 may be configured to cancel the power saving mode and supply power to the sensor 103, the detection unit 104, the buffer 105, the drive unit 106 and the display unit 107, in the case where the communication unit 108 receives a signal from another apparatus. According to this configuration, power consumption of the display apparatus 10 can be suppressed. Note that a configuration may be adopted in which the operation clock of the CPU in the control unit 100 is set to a lower frequency than normal in the power saving mode.

In the abovementioned embodiments, the display apparatus 10 may be configured to, when the image to be displayed is changed, store the image that was displayed before the change, and to display the image that was displayed before the change based on the stored image, in the case where an operation for instructing display of the image that was displayed before the change is performed. For example, a configuration may be adopted in which the image that was displayed before the change is displayed in the case where a button provided in the display apparatus is operated. According to this configuration, a page that was previously being viewed can be displayed with a simple operation.

In the abovementioned first embodiment, in the case where a document file that was searched by one display apparatus 10 is not stored in another display apparatus 10 that is coordinated, the document file is transmitted to the other display apparatus 10, but the invention is not limited to this configuration. For example, a configuration may be adopted in which one display apparatus acquires position information associated with a line tapped with the stylus pen 40 in a list of search results, extracts the data of the page having the page number included in the acquired position information from a document file having the filename included in the position information, and transmits the extracted data for one page of the document to another display apparatus 10 that is coordinated. In the case where the document is a PDF file, the display apparatus 10A may create a separate PDF file from the extracted page of data, and transmit the separate file consisting of one page of data. Also, the extracted page and several pages before and/or after the extracted page may be transmitted, or only pages that contain the search key may be created as a separate file and transmitted. According to this configuration, the amount of communication at the time of transmission can be reduced, compared with a configuration in which the whole document file is transmitted.

In the abovementioned embodiments, the display apparatus 10 that displays the list of search results transmits the document file that was searched to another display apparatus 10 that is coordinated, in the case where the other display apparatus 10 that is coordinated does not store the document file, but the invention is not limited to this configuration. For example, a configuration may be adopted in which the display apparatus 10 that displays the list of search results transmits the position information associated with the line that was tapped with the stylus pen 40 in the list of search results, in the case where the other display apparatus 10 that is coordinated stores document file that was searched, and transmits image data of the page having the page number included in the position information associated with the line that was tapped with the stylus pen 40 in the list of search results to the other display apparatus 10 that is coordinated, in the case where the other display apparatus 10 does not store the document file that was searched. Also, image data of the page having the page number and pages before and/or after that page may be generated and transmitted. Also, image data of only pages containing the search key may be generated and transmitted. As a result of the display apparatus 10A generating and transmitting image data or transmitting image data that has already been generated, the display apparatus 10B that receives the image data does not need to generate image data for display from the document file.

In the abovementioned embodiments, the document file format is PDF, but may be another format such as HTML (HyperText Markup Language) or XML (Extensible Markup Language). For example, in the case where the document file format is HTML, the position information that is generated in the character string search consists of a filename, a hit number and a keyword, and does not include a page number. For example, in the case where the display apparatus 10B receives a document file and position information transmitted from the display apparatus 10A that performed a keyword search, the display apparatus 10B searches the received document file for the keyword specified by the hit number, and displays portions of HTML document in which keyword was found in the search.

In the abovementioned embodiments, a configuration may be adopted in which, in the case where an operation for changing the page that is displayed is performed after the display apparatus 10B has displayed a page corresponding to a search result, the keyword included in the acquired position information is clearly identified in the image of the page after the change. According to this configuration, hits for the keyword can be easily found even on the page after the change.

In the abovementioned embodiments, the display apparatus 10 performs communication in accordance with Bluetooth communication standards when communicating with another display apparatus 10, but may communicate via a wireless LAN access point. Also, the display apparatuses 10 are not limited to communicating with each other through wireless communication, and may be connected to each other with a cable and communicate via the cable.

In the invention, a configuration may be adopted in which, when a hyperlink is tapped in the display apparatus 10A in the case where the document file format is HTML, the display apparatus 10A transmits the URL of the hyperlink that is tapped to the display apparatus 10B, and the display apparatus 10B displays the document specified by the transmitted URL.

Also, a link may be added to a character string in a PDF document. For example, position information that includes the document filename of the document and the page number of the page on which the diagram corresponding to “FIG. 3” appears in the document may be added to the portion of “FIG. 3” in the document illustrated in FIG. 4. In the case where the portion of “FIG. 3” is tapped with the stylus pen 40 in the display apparatus 10A, the display apparatus 10A transmits the position information added to the portion of “FIG. 3” to the display apparatus 10B. The display apparatus 10B acquires the document file having the filename included in the transmitted position information, specifies, in the acquired document file, the page having the page number included in the position information, and displays an image of the specified page. Since a character string is also an example of an object in this configuration, the document to which a link has been added can be referred to as an example of a list of objects.

Computer programs that are executed by the display apparatus 10 and the computer apparatus 20 may be installed from a state of being stored on a computer-readable recording medium such as a magnetic recording medium (magnetic tape, magnetic disk (HDD (Hard Disk Drive), FD (Flexible Disk)), etc.), an optical recording medium (optical disc etc.), a magneto-optical recording medium, or a semiconductor memory. The computer programs may also be installed by being downloaded via a communication line.

This application claims priority from Japanese Patent Application No. 2014-022432 filed in the Japanese Patent Office on Feb. 7, 2014 the entire disclosure of which is hereby incorporated by reference in its entirely.

What is claimed is:

1. A display system comprising:
a first display apparatus; and
a second display apparatus,
the first display apparatus including:
a first display unit;
a first list generation unit that generates, for display on the first display unit, a list of objects that are in a document; and
a first transmission unit that transmits first position information showing a position of an object selected from the list displayed on the first display unit to the second display apparatus, and
the second display apparatus including:
a second display unit;
a second reception unit that receives the first position information transmitted from the first display apparatus; and
a second display control unit that causes the second display unit to display a position that is specified by the first position information received by the second reception unit,
wherein the second display apparatus includes:
a second list generation unit that generates, for display on the second display unit, a list of objects that are in a document; and
a second transmission unit that transmits second position information showing a position of an object selected from the list displayed on the second display unit to the first display apparatus, and
the first display apparatus includes:
a first reception unit that receives the second position information transmitted from the second display apparatus; and
a first display control unit that causes the first display unit to display a position that is specified by the second position information received by the first reception unit.

2. The display system according to claim 1,
wherein the first display apparatus and the second display apparatus cancel transmission of the position information, in a case where the other display apparatus is performing communication at a time of starting transmission of the position information.

3. The display system according to claim 1,
wherein, in the first display apparatus, in a case where there is not a display apparatus to serve as a transmission destination of the first position information, the first display control unit causes the first display unit to display the position that is specified by the first position information, and
in the second display apparatus, in a case where there is not a display apparatus to serve as a transmission destination of the second position information, the second display control unit causes the second display unit to display the position that is specified by the second position information.

4. The display system according to claim 1,
wherein the first display apparatus and the second display apparatus transition to a power saving mode, in a case where a user operation is not performed within a predetermined time period.

5. The display system according claim 1,
wherein the document is a document divided into pages, and
the position information includes a page number and document identification information that indicates the document.

6. The display system according to claim 5,
wherein the list is a list of search results for objects, and
the position information includes document identification information, a search keyword, and a page number of a page containing the keyword.

7. The display system according claim 1 comprising:
a third display unit;
a third list generation unit that generates, for display on the third display unit, a list of objects that are in a document;
a third transmission unit that transmit third position information showing a position of an object selected from the list displayed on the third display unit to another display apparatus;
a third reception unit that receives position information transmitted from another display apparatus; and
a third display control unit that causes the third display unit to display a position that is specified by the position information received by the third reception unit.

8. The display system according claim 1,
wherein the display apparatuses, in a case where a predetermined operation is performed, display an image that was displayed immediately before an image being displayed when the operation was performed.

9. A display apparatus comprising:
a display unit;
a list generation unit that generates, for display on the display unit, a list of objects that are in a document;
a transmission unit that transmits position information showing a position of an object selected from the list displayed on the display unit to another display apparatus;
a reception unit that receives position information transmitted from another display apparatus; and
a display control unit that causes the display unit to display a position that is specified by the position information received by the reception unit.

10. A display method comprising:
a list generation step of generating, for display on a display unit, a list of objects that are in a document;
a transmission step of transmitting position information showing a position of an object selected from the list displayed on the display unit to another display apparatus;
a reception step of receiving the position information transmitted from another display apparatus; and
a display control step of causing the display unit to display a position that is specified by the position information received in the reception step.

11. A computer program for causing a computer to execute:
a list generation step of generating, for display on a display unit, a list of objects that are in a document;
a transmission step of transmitting position information showing a position of an object selected from the list displayed on the display unit to another display apparatus;
a reception step of receiving the position information transmitted from another display apparatus; and
a display control step of causing the display unit to display a position that is specified by the position information received in the reception step.
